(19) United States
(12) Patent Application Publication
(10) Pub. No.: US 2002/0140278 A1
(43) Pub. Date: Oct. 3, 2002

(54) Seat restraint tensioner

(76) Inventors: David Gerard Hlavaty, Northville, MI (US); James Lloyd Webber, Shelby Township, MI (US)

Correspondence Address: KATHRYN A. MARRA, DELPHI TECHNOLOGIES, INC., P.O. Box 5052, Mail Code: 480-414-420, Troy, MI, 48007-5052, US

(21) Appl. No.: 09/812,063

(22) Filed: Mar. 19, 2001

(51) Int. Cl. B60R 21/00

(52) U.S. Cl. 297/464

(57) ABSTRACT

A seat restraint tensioner for a seat restraint system in a vehicle includes a housing for operative connection to vehicle structure and a movable piston disposed in the housing. The seat restraint tensioner also includes a gas generator operatively connected to the housing for expelling a gas to move the piston. The seat restraint tensioner further includes a spool assembly operatively connected to the piston and for connection to belt webbing of the seat restraint system for pulling-down the belt webbing of the seat restraint system in a linear manner and winding up the belt webbing on the spool assembly as the piston moves.

### TECHNICAL FIELD

The present invention relates generally to seat restraint systems for vehicles and, more particularly, to a seat restraint tensioner for a seat restraint system in a vehicle.

### BACKGROUND OF THE INVENTION

It is known to provide a seat restraint system such as a seat belt in a vehicle to restrain an occupant in a seat of the vehicle. In some vehicles, the seat restraint system may be a lap belt, a shoulder belt or both. Typically, the lap belt and shoulder belt are connected together at one end. The seat restraint system includes a latch plate at the connected end. The seat restraint system also includes a buckle connected at one end by webbing or the like to vehicle structure. The buckle receives the latch plate to be buckled together. When the buckle and latch plate are buckled together, the seat restraint system restrains movement of the occupant to help protect the occupant during a collision.

It is also known to provide a seat belt tensioner in the seat restraint system for tensioning an

It is also known to provide a seat belt tensioner in the seat restraint system for tensioning an occupant belt restraint in the event of sudden vehicle deceleration. An example of such a seat belt tensioner is disclosed in U.S. Pat. No. 5,492,368 to Pywell. In this patent, the seat belt tensioner has a housing with a piston slidably mounted therein and a seat belt reel attached to a shaft of the piston. The seat belt tensioner is operated by pushing a piston with pyrotechnically generated gas and mechanically translating that force into seat belt reeling to wind the belt and produce seat belt tensioning. However, obtaining sufficient rotary action to take up a relatively large amount of webbing of the belt is difficult and inefficient. Also, these seat belt tensioners have a relative thick profile package. Further, these seat belt tensioners pulling on a shoulder belt are very inefficient to pull an occupant into a seat and loads applied to the occupant through the shoulder belt are in the upper shoulder and chest area of the occupant.

Therefore, it is desirable to provide a new seat restraint tensioner for a lap belt of a seat restraint system of a vehicle. It is also desirable to provide a seat restraint tensioner with linear travel for a seat vehicle. It is still further desirable to provide a seat restraint tensioner for a seat restraint system in a vehicle that has a thinner profile package.

### SUMMARY OF THE INVENTION

It is, therefore, one object of the present invention to provide a seat restraint tensioner for a seat restraint system in a vehicle.

It is another object of the present invention to provide a seat restraint tensioner for a seat restraint system in a vehicle that actuates in a linear manner.

To achieve the foregoing objects, the present invention is a seat restraint tensioner for a seat restraint system in a vehicle including a housing for operative connection to vehicle structure and a movable piston disposed in the housing. The seat restraint tensioner also includes a gas generator operatively connected to the housing for expelling a gas to move the piston. The seat restraint tensioner further includes a spool assembly operatively connected to the piston and for connection to belt webbing of the seat restraint system for pulling-down the belt webbing of the seat restraint system in a linear manner and winding up the belt webbing on the spool assembly as the piston moves.

One advantage of the present invention is that a new seat restraint tensioner is provided for a seat restraint system in a vehicle. Another advantage of the present invention is that the seat restraint tensioner is of a linear type to pull-down a lap belt of the seat restraint system to restraint an occupant in the vehicle. Yet another advantage of the present invention is that the seat restraint tensioner is more efficient and directly removes slack in the lap belt area of the seat restraint system. Still another advantage of the present invention is that the seat restraint tensioner provides hyper-tensioning for vehicle rollovers and load limiting for vehicle frontal impacts. A further advantage of the present invention is that the seat restraint tensioner imparts loads to the occupant that are transferred through the lap belt, and therefore, the thigh and pelvic areas receive the load and pull the occupant into the seat. Yet a further advantage of the present invention is that the seat restraint tensioner has a relatively low mass, spool take-up for webbing, and thin profile packaging than current rotary pretensioners.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an elevational view of a seat restraint tensioner, according to the present invention, illustrated in operational relationship with a seat restraint system of a vehicle.

FIG. 2 is an enlarged perspective view of the seat restraint tensioner of FIG. 1.

FIG. 3 is a plan view of the seat restraint tensioner of FIG. 1.

FIG. 4 is a sectional view taken along line 44 of FIG. 3.

FIG. 5 is a side elevational view of the seat restraint tensioner of FIG. 1.

FIG. 6 is a side elevational view of the seat restraint tensioner of FIG. 1.

FIG. 7 is a graph of force versus time for the seat restraint tensioner of FIG. 1.

### DESCRIPTION OF THE PREFERRED EMBODIMENT

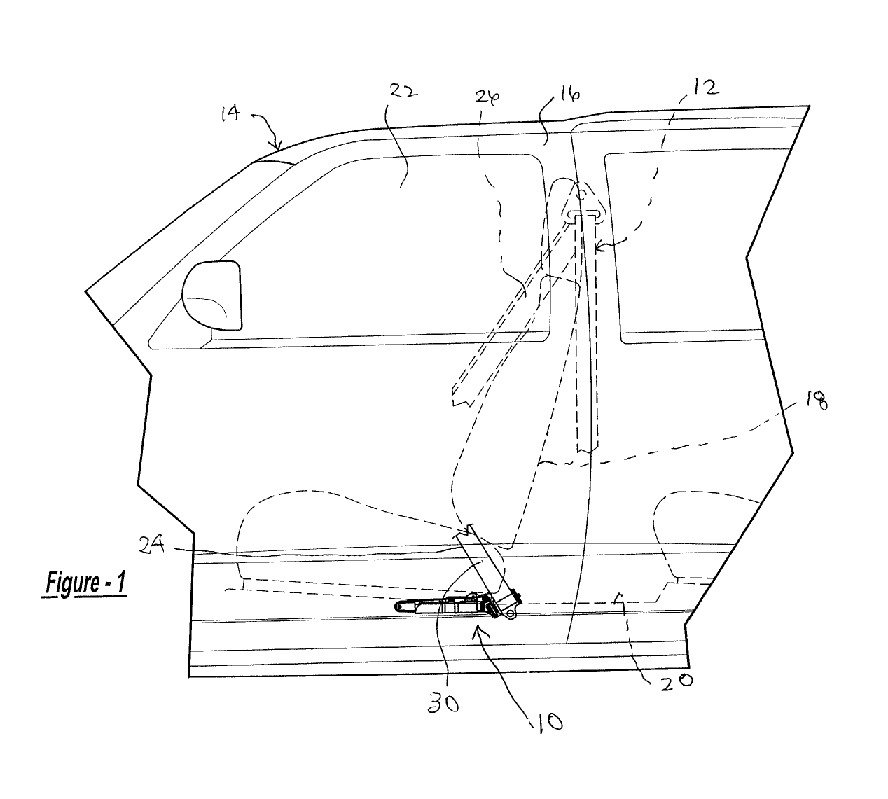

Referring to the drawings and in particular FIG. 1, one embodiment of a seat restraint tensioner 10, according to the present invention, is shown for a seat restraint system, generally indicated at 12, in a vehicle (partially shown), generally indicated at 14. The vehicle 14 includes a vehicle body 16 and a seat 18 mounted by suitable means to vehicle structure 20 such as a floorpan in an occupant compartment 22 of the vehicle body 16. In this embodiment, the seat 18 is a front seat of the vehicle 14. It should be appreciated that the seat 18 could be a rear, second row, or third row seat for the vehicle 14.

The vehicle 14 includes the seat restraint system 12 for restraining an occupant (not shown) in the seat 18. The seat restraint system 12 includes a latch tongue or plate (not shown) connected to an end of either one of a lap belt 24, shoulder belt 26, or both. In this embodiment, the shoulder belt 26 has another end connected to a seat belt retractor (not shown). The lap belt 24 has belt webbing 30 connected to the seat restraint tensioner 10, which, in turn, is connected by suitable means to the vehicle structure 20 or the seat 18. The seat restraint system 12 also includes a buckle assembly (not shown) connected by suitable means such as belt webbing (not shown) and an anchor plate (not shown) to the vehicle structure 20 or the seat 18. The latch plate is engageable and disengageable with the buckle assembly as is known in the art. It should be appreciated that, in a preferred embodiment, the seat restraint tensioner 10 is mounted to an outboard side of the seat 18 and the seat restraint tensioner 10 extends toward a front of the vehicle 14. It should also be appreciated that, except for the seat restraint tensioner 10, the seat restraint system 12 and vehicle 14 are conventional and known in the art.

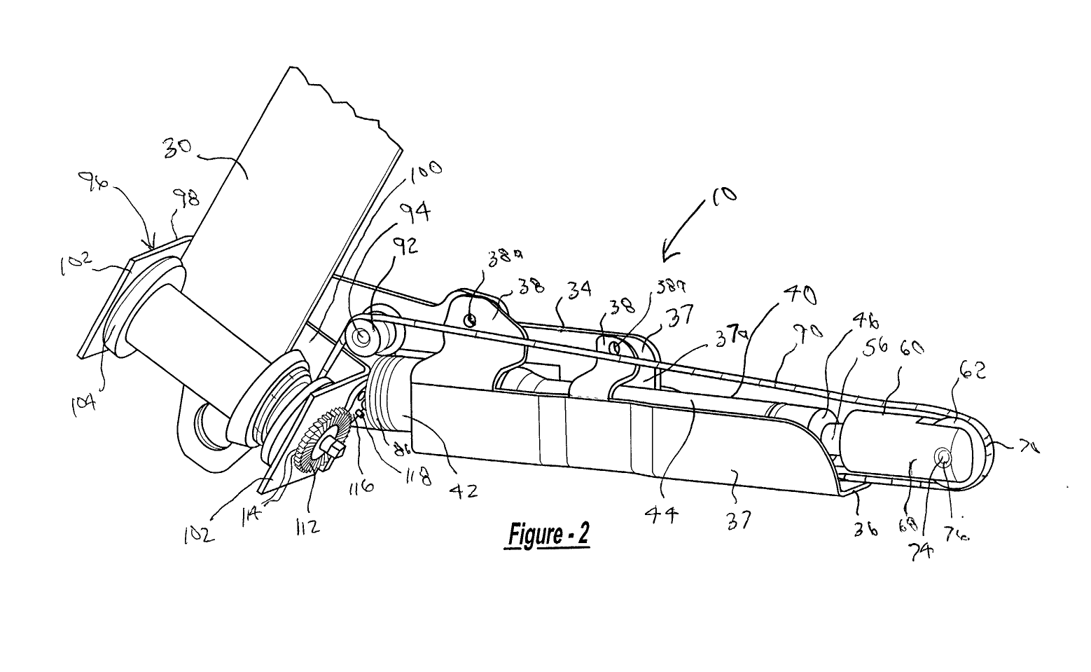

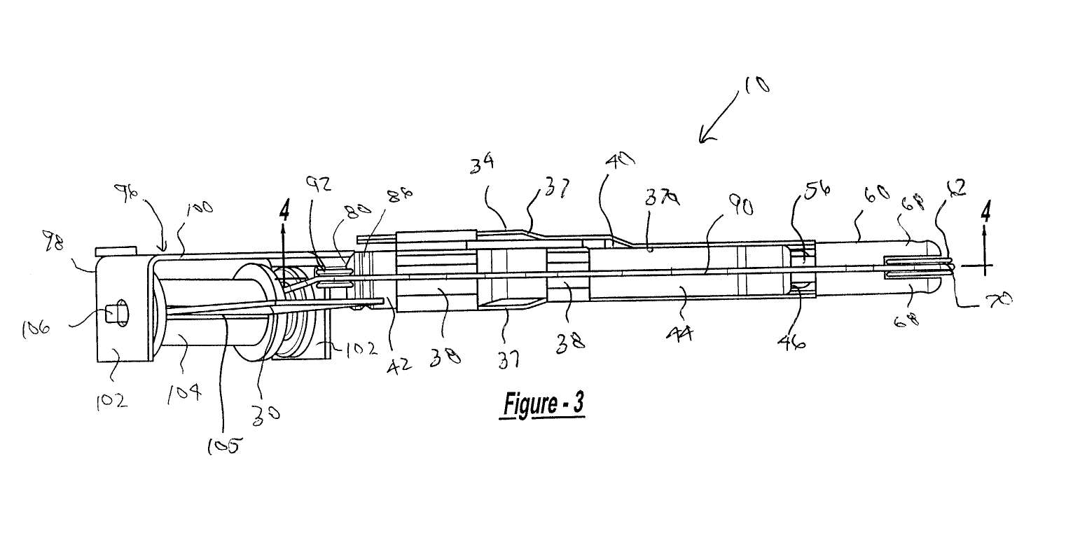

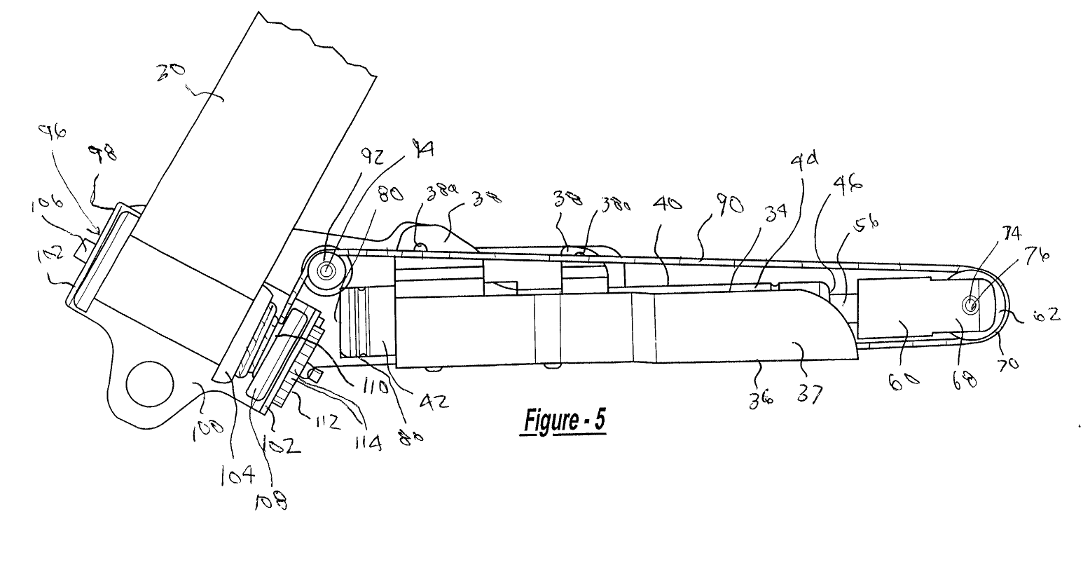

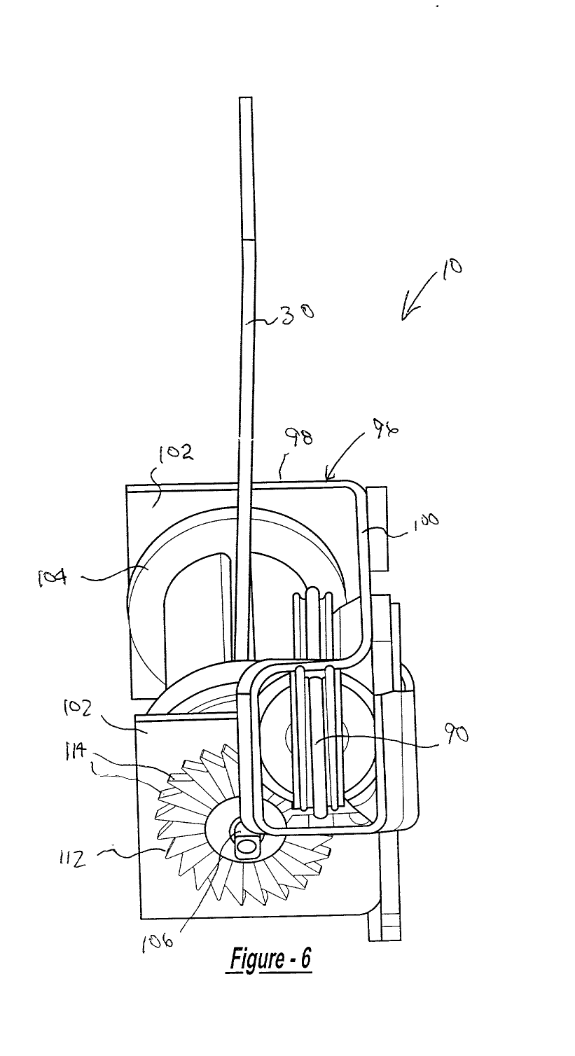

Referring to FIGS. 1 through 6, the seat restraint tensioner 10, according to the present invention, includes an anchor bracket 34 connected to the vehicle structure 20 or seat 18 by suitable means such as anchor bolts (not shown). The bracket 34 is made of a metal material such as high strength steel. The bracket 34 includes a first portion formed by a generally planar base wall 36 and a pair of side walls 37 extending generally perpendicular thereto to form a channel 37a. One of the side walls 37 has a pair of attachment flanges 38 extending upwardly and across the channel 37a to the other side wall 37. Each of the flanges 38 have an aperture 38a extending therethrough to receive a fastener (not shown) for attaching the bracket 34 to the vehicle structure 20 or seat 18.

The seat restraint tensioner 10 also includes a housing 40 disposed in the channel 37a and fixed or held therein by the flanges 38 and a projection 40a extending from one of the side walls 37 and into an annular groove 40b of the housing 40. The housing 40 has a first or piston portion 42 extending longitudinally. The piston portion 42 is generally tubular in shape with a generally circular cross-sectional shape. The housing 40 also includes a tube portion 44 extending longitudinally from the piston portion 42. The tube portion 44 is generally tubular in shape with a generally circular cross-sectional shape. The tube portion 44 has a diameter less than a diameter of the piston portion 42. The tube portion 44 has a closed end 46 and the piston portion 42 has an open end 48. The housing 40 is made of a metal material such as steel or aluminum. The housing 40 is a monolithic structure being integral, unitary, and one-piece.

The seat restraint tensioner 10 includes a piston 50 disposed in the piston portion 42 of the housing 40. The piston 50 is generally cylindrical in shape for sliding movement in the tube portion 44. The piston 50 has an annular groove 52 and a seal 54 such as an O-ring disposed in the annular groove 52 to form a seal with an interior surface of the tube portion 44 to prevent gases from escaping past the piston 50. The piston 50 may include an orifice or passageway 53 extending therethrough to provide a metering action of gas or pressure from one side of the piston 50 to the other. The piston 50 is made of a metal material such as steel.

The seat restraint tensioner 10 includes a shaft or rod 56 disposed partially in the tube portion 44 of the housing 40. The rod 56 extends longitudinally and is generally cylindrical in shape with a generally circular cross-sectional shape. The rod 56 extends longitudinally and has one end connected to the piston 50 by suitable means such as welding and another end extending through an aperture 58 in the closed end 46 of the housing 40. The rod 56 is made of a metal material such as steel. It should be appreciated that the piston 50 and rod 56 may be integral, unitary, and one-piece.

The seat restraint tensioner 10 includes a guide member 59 disposed in and connected to the end of the tube portion 44 of the housing 40. The guide member 59 extends longitudinally and has an aperture 59a extending therethrough to receive a portion of the rod 56. The guide member 59 is a cylindrical member having a generally circular cross-sectional shape to guide the rod 56 linearly when moved. The guide member 59 is secured to the tube portion 44 by suitable means such as press fitting. The guide member 59 is made of a metal material such as steel.

The seat restraint tensioner 10 includes a pulley holder 60 connected to the end of the rod 56 and at least one rotatable pulley 62 connected to the end of the pulley holder 60. The pulley holder 60 extends axially and is generally cylindrical in shape. The pulley holder 60 has a cavity or recess 64 extending axially into one end to receive a reduced diameter portion 66 of the rod 56. The pulley holder 60 also has a pair of flanges 68 extending outwardly and spaced laterally to receive the pulley 62. The pulley 62 is generally circular in shape and has an annular groove 70 for a function to be described. The pulley 62 has an aperture 72 extending therethrough. The seat restraint tensioner 10 includes a pin 64 extending through the aperture 72 in the pulley 62 and an aperture 76 in the flanges 68. It should be appreciated that the pulley 62 rotates relative to the pulley holder 60.

The seat restraint tensioner 10 also includes a gas generator 80 disposed in the piston portion 42 of the housing 40. The gas generator 80 is a pyrotechnic device similar to that used for inflators in inflatable restraint systems to expel a gas into the housing 40. The gas generator 80 includes an electrical connector (not shown) connected to a source of power (not shown) for activating the pyrotechnic device to expel the gas. The gas generator 80 extends through the open end 48 in the piston portion 42 of the housing 40. The gas generator 80 is secured in the piston portion 42 by suitable means such as by a flange 82 at the end of the piston portion 42 and a projection 84 extending from piston portion 42 and into an annular groove 86 of the gas generator 80. It should be appreciated that the gas expelled by the pyrotechnic device of the gas generator 80 will move the piston 50 longitudinally in the tube portion 44 of the housing 40. It should also be appreciated that the gas generator 80 may be a stored compressed gas used with an electrical trigger in place of a pyrotechnic device.

The seat restraint tensioner 10 also includes at least one cable 90 having one end attached to the base wall 36 of the bracket 34 by suitable means such as by extending through a flange (not shown) thereof and retained by a plug member (not shown). The cable 90 is disposed in the groove 70 of the pulley 62 and extends over the pulley 62. The cable 90 extends over the flanges 38 of the bracket 34 and over a guide or pulley 92 rotatably attached to the bracket 34 by suitable means such as a pin 94. The cable 90 has another end connected to a spool assembly 96 to be described. The cable 90 is made of a metal material such as steel. It should be appreciated that the guide 92 rotates about the pin 94.

The seat restraint tensioner 10 includes a spool assembly, generally indicated at 96, connected to the belt webbing 30 and the bracket 34. The spool 96 includes a frame 98 having a base wall 100 and a pair of side walls 102 extending generally perpendicular thereto. The frame 98 is connected to the anchor bracket 34 by suitable means such as welding or fasteners (not shown). The frame 98 is made of a metal material such as high strength steel. It should be appreciated that the frame 98 may be connected by suitable means such as an anchor bolt (not shown) to the seat 18 or the vehicle structure 20.

The spool assembly 96 includes a take-up reel or spool 104 disposed between the side walls 102 and operatively connected to the belt webbing 30 and the frame 98. The belt webbing 30 has a loop (not shown) at one end extending through a slot 105 in the spool 104. The spool assembly 96 also includes a shaft or torsion bar 106 extending through the loop at the end of the belt webbing 30 and through a center of the spool 104 and through the side walls 102 of the frame 98 such that the spool 104 is rotatable relative to the frame 98. It should be appreciated that the belt webbing loop, torsion bar 106, and drum 104 provide a secure attachment for seat belt loads into the frame 98 and anchor bracket 34.

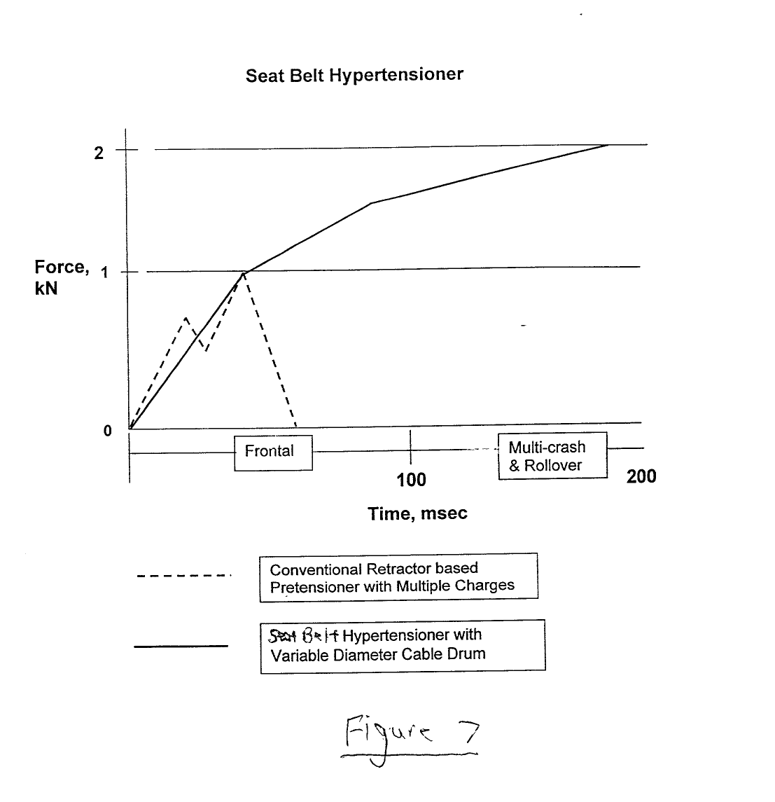

The spool assembly 96 also includes a drum 108 disposed about the torsion bar 106 and connected to the spool 104. The drum 108 is preferably integral with the spool 104 for the cable 90 to wrap around. The drum 108 has a variable diameter groove 110 extending circumferentially and axially thereabout to allow initially a fast rate with low load and finally a slower rate at higher load as illustrated in FIG. 7. The end of the cable 90 is connected to the spool 104 by suitable means such as extending through a flange (not shown) thereof and retained by a plug member (not shown).

The spool assembly 96 includes a locking sprocket 112 attached to and rotatable with the end of the torsion bar 106 adjacent the drum 108 on the other side of the side wall 102 of the frame 98. The locking sprocket 112 has a plurality of teeth 114 disposed circumferentially thereabout. The spool assembly 96 also includes a locking pawl 116 pivotally connected to a side wall 102 of the frame 98 by suitable means such as a pin 118. The spool assembly 96 may include a spring (not shown) disposed between the locking pawl 116 and the side wall 102 to urge the locking pawl 116 toward the sprocket 112. The locking pawl 116 is engageable with the teeth 114 to lock the torsion bar 106 relative to the frame 98. It should be appreciated that after the belt webbing 30 is wound on the spool 104, the locking pawl 50 pivots and engages the teeth 114 to lock the torsion bar 106 against rotation to prevent unwinding of the belt webbing 30.

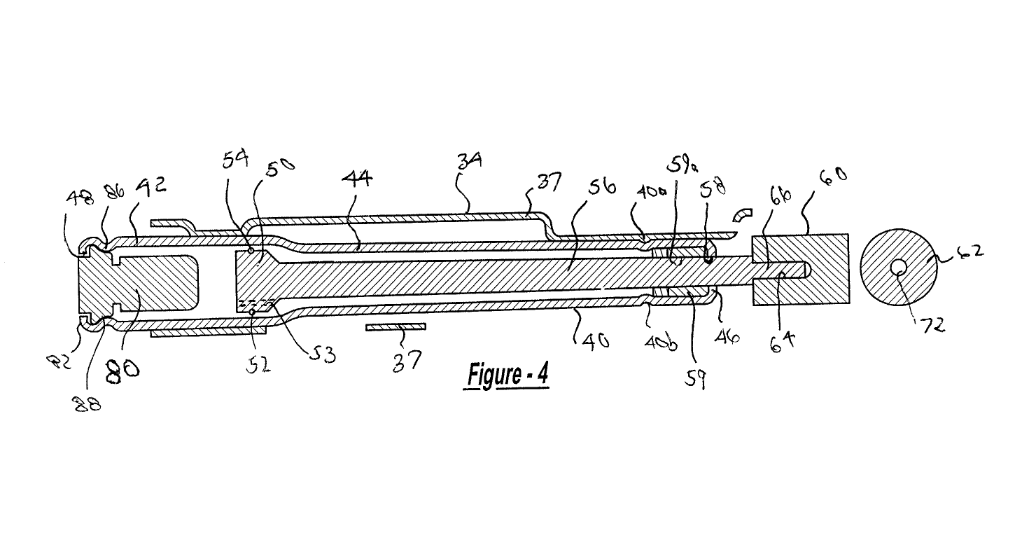

In operation of the seat restraint tensioner 10, an occupant (not shown) grasps the latch plate and engages the latch plate with the buckle assembly to restrain the occupant in the seat 18. The seat restraint tensioner 10 is in an initial or first operative position as illustrated in FIGS. 1 and 4.

When the vehicle 14 experiences either a rollover or a collision-indicating condition of at least a predetermined threshold level as sensed by rollover or impact sensors (not shown), an electrical signal is sent by a control module (not shown) to the gas generator 80. The gas generator 80 is activated and a gas is expelled by the pyrotechnic device into the piston portion 42 of the housing 40. It should be appreciated that the gas is generated very quickly and completely in a sufficient volume before the piston 50 moves. The force, due to the pressure, of the gas against the piston 50 causes the piston 50 to move longitudinally in the piston portion 42 toward the closed end 46 of the housing 40. Since the piston portion 42 has a inner diameter larger than an outer diameter of the piston 50, the piston 50 has a relatively fast travel for a predetermined distance. The piston 50 then reaches a point in the housing 40 where the outer diameter of the piston 50 is the same as the inner diameter of the tube portion 44. The piston 50 has the passageway 53 extending therethrough to provide a metering action from one side of the piston 50 to the other. The piston 50 also provides a differential area from one face of the piston 50 to the other face. Since the area is greater on face-one versus face-two, the piston 50 will push the rod 56 forward, pulling on the cable 90. The rod 56 and pulley 62 move forward at the same rate and distance as the rod 56 and piston 50. Since the cable 90 is wrapped around the pulley 62, the cable 90 travels a predetermined distance such as 2.0 mm for every 1.0 mm of rod 56 travel.

The cable 104 is wrapped around the drum 108 and connected to the spool 104 to rotate the spool 104 and take up the belt webbing 30 and store it on the spool 104. As a result, the lap belt 24 is pulled downward in a linear manner toward the anchor bracket 34 to take up slack in the seat restraint system 12. Since the lap belt 24 is latched to the buckle assembly and in position around the waist of the occupant, the resulting action will be to pull the occupant down into the seat 18 and secure the occupant in the seat 18. The locking pawl 116 is biased by the spring to mate with the teeth 114 in the sprocket 112 to provide a locking condition to prevent the spool 104 and belt webbing 30 from reversing as the occupant loads the lap belt 24 during the rollover or collision. It should be appreciated that the force of the gas is mechanically transferred to the spool 104 by pulling on the cable 90. It should also be appreciated that the seat restraint tensioner 10 may be used for either a rollover condition or a frontal impact condition.

Accordingly, the seat restraint tensioner 10 can be used for a frontal impact condition in which the gas generator 80 is fired and load limiting is provided to reduce chest loads on the occupant. The seat restraint tensioner 10 can also be used for a rollover condition in which the gas generator 80 is fired pulling in approximately 300 mm of belt webbing 30 and the occupant into the seat 18, increasing head clearance for the occupant relative to a roof (not shown) of the vehicle 12. The seat restraint tensioner 10 is a combination linear/rotary device that is mounted to the outboard side of the seat 18 and imparts loads to the occupant through the lap belt 24 and, therefore, to the thigh and pelvic areas of the occupant and pull the occupant into the seat 18.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A seat restraint tensioner for a seat restraint system in a vehicle comprising:
a housing for operative connection to vehicle structure;
a movable piston disposed in said housing;
a gas generator operatively connected to said housing for expelling a gas to move said piston; and
a spool assembly operatively connected to said piston and for connection to belt webbing of the seat restraint system for pulling-down the belt webbing of the seat restraint system in a linear manner and winding up the belt webbing on said spool assembly as said piston moves.

2. A seat restraint tensioner as set forth in claim 1 including a bracket connected to said housing and for operative connection to vehicle structure.

3. A seat restraint tensioner as set forth in claim 1 including a cable having one end operatively connected to said spool assembly and another end operatively connected to said piston.

4. A seat restraint tensioner as set forth in claim 3 including a guide operatively connected to said housing between said piston and said spool assembly.

5. A seat restraint tensioner as set forth in claim 4 including a rod connected to said piston and extending through an end of said housing.

6. A seat restraint tensioner as set forth in claim 5 including a pulley operatively connected to said rod, said cable extending over said pulley.

7. A seat restraint tensioner as set forth in claim 6 including a pulley holder connected to said rod and said pulley, said pulley being rotatable relative to said rod.

8. A seat restraint tensioner as set forth in claim 3 wherein said spool assembly comprises a frame, a torsion bar rotatably connected to said frame, and a spool disposed about said torsion b ar, the belt webbing being disposed about said spool.

9. A seat restraint tensioner as set forth in claim 8 including a drum connected to said spool and said cable for rotating said spool as said cable moves.

10. A seat restraint tensioner as set forth in claim 9 wherein said drum has a variable diameter groove to receive said cable.

11. A seat restraint tensioner as set forth in claim 8 including a locking device to prevent reverse travel of the belt webbing.

12. A seat restraint tensioner as set forth in claim 11 wherein said locking device includes a sprocket connected to said torsion bar having a plurality of teeth spaced circumferentially thereabout and a locking pawl pivotally connected to said frame and mating with one of said teeth to provide a locking condition.

13. A seat restraint tensioner as set forth in claim 1 wherein said housing comprises a piston portion extending longitudinally and a tube portion extending longitudinally from said piston portion and having a diameter less than a diameter of said piston portion.

14. A seat restraint tensioner as set forth in claim 1 wherein said gas generator comprises a pyrotechnic device to expel a gas.

15. A seat restraint tensioner for a seat restraint system in a vehicle comprising:
a bracket for operative connection to vehicle structure;
a housing connected to said bracket;
a movable piston disposed in said housing;
a spool assembly connected to said bracket and for connection to belt webbing of the seat restraint system;
a cable having one end operatively connected to said spool assembly and another end operatively connected to said piston; and
a gas generator operatively connected to said housing for expelling a gas to move said piston and linearly pull-down the belt webbing toward said base plate.

16. A seat restraint tensioner as set forth in claim 15 wherein said housing comprises a piston portion extending longitudinally and a tube portion extending longitudinally from said piston portion and having a diameter less than a diameter of said piston portion.

17. A seat restraint tensioner as set forth in claim 16 wherein said gas generator comprises a pyrotechnic device connected to said housing to expel a gas in said gas generation portion.

18. A seat restraint tensioner as set forth in claim 15 wherein said spool assembly comprises a frame, a torsion bar rotatably connected to said frame, and a spool disposed about said torsion bar, the belt webbing being disposed about said spool.

19. A seat restraint tensioner as set forth in claim 18 including a drum connected to said spool and said cable for rotating said spool as said cable moves.

20. A seat restraint tensioner as set forth in claim 20 wherein said drum has a variable diameter groove to receive said cable.

21. A seat restraint tensioner as set forth in claim 18 including a locking device to prevent reverse travel of the belt webbing.

22. A seat restraint tensioner as set forth in claim 21 wherein said locking device includes a sprocket connected to said torsion bar having a plurality of teeth spaced circumferentially thereabout and a locking pawl pivotally connected to said frame and mating with one of said teeth to provide a locking condition.

23. A seat restraint tensioner as set forth in claim 15 including a rod connected to said piston and extending through an end of said housing.

24. A seat restraint tensioner as set forth in claim 23 including a pulley operatively connected to said rod, said cable extending over said pulley.

25. A seat restraint tensioner as set forth in claim 24 including a pulley holder connected to said rod and said pulley, said pulley being rotatable relative to said rod.

26. A seat restraint tensioner as set forth in claim 25 including a guide connected to said bracket between said pulley and said spool assembly, said cable extending over said guide.

27. A seat restraint system for a vehicle comprising:
a belt webbing having a first end for connection to a buckle and a second end;
a bracket for connection to vehicle structure of the vehicle;
a spool assembly having a frame connected to said bracket, a torsion bar rotatably connected to said frame, a spool disposed about said torsion bar, and a drum connected to said spool having a variable diameter groove, said second end of said belt webbing being disposed about said spool;
a housing connected to said bracket;
a movable piston disposed in said housing;
a cable disposed in said groove of said drum and operatively connected to said spool and operatively connected to said piston; and
a gas generator operatively connected to said housing for expelling a gas to move said piston and rotate said spool to linearly pull-down said belt webbing toward said bracket and winding up said belt webbing on said spool.

28. A seat restraint tensioner as set forth in claim 27 including a locking device to prevent reverse travel of the belt webbing.

29. A seat restraint tensioner as set forth in claim 28 wherein said locking device includes a sprocket connected to said torsion bar having a plurality of teeth spaced circumferentially thereabout and a locking pawl pivotally connected to said frame and mating with one of said teeth to provide a locking condition.
